(19) United States
(12) Patent Application Publication
(10) Pub. No.: US 2013/0130184 A1
(43) Pub. Date: May 23, 2013

(54) Apparatus and Method for Controlling Wafer Temperature

(71) Applicants: Chang-Shen Lu, New Taipei City (TW); Tze-Liang Lee, Hsin-Chu (TW); Yi-Hung Lin, Taipei (TW); Tai-Chun Huang, Hsin-Chu (TW); Pang-Yen Tsai, Jhu-Bei City (TW); Jr-Hung Li, Chupei City (TW)

(72) Inventors: Chang-Shen Lu, New Taipei City (TW); Tze-Liang Lee, Hsin-Chu (TW); Yi-Hung Lin, Taipei (TW); Tai-Chun Huang, Hsin-Chu (TW); Pang-Yen Tsai, Jhu-Bei City (TW); Jr-Hung Li, Chupei City (TW)

(73) Assignee: Taiwan Semiconductor Manufacturing Company, Ltd., Hsin-Chu (TW)

(21) Appl. No.: 13/301,501

(22) Filed: Nov. 21, 2011

(51) Int. Cl. F27D 21/00

(52) U.S. Cl. 432/1; 432/32

(57) ABSTRACT

A wafer temperature control apparatus comprises a first temperature sensor and a second temperature sensor. The first temperature sensor is configured to receive a first temperature signal from a center portion of a backside of a susceptor. The second temperature sensor is configured to receive a second temperature signal from an edge portion of the susceptor. A plurality of controllers are configured to adjust each heating source's output based upon the first temperature signal and the second temperature signal.

### BACKGROUND

Emerging applications, such as microprocessors, memory integrated circuits and other high density devices have an increasing demand for epitaxially grown silicon wafers. Epitaxially grown silicon wafers require precise control of fabrication process parameters so as to reduce operation and process variations and improve the quality, performance and yield of epitaxially grown silicon wafers.

In the manufacturing process of epitaxially grown silicon wafers, an important step is wafer temperature controlling during an epitaxial growth process. A non-uniform temperature distribution on an epitaxially grown silicon wafer may generate different chemical reaction rates at different portions of the epitaxially grown silicon wafer. As a result, the deposition rate difference on the epitaxially grown silicon wafer may cause an uneven surface. Such an uneven surface may lead to defects in subsequent fabrication processes, such as a defect in the photolithography process due to the uneven surface of the wafer. On the other hand, the uniformity of an epitaxially grown silicon wafer can be improved by precisely controlling the temperature of the epitaxially grown silicon wafer when an epitaxial layer is deposited on the silicon wafer.

In the conventional art, during an epitaxial growth process, a silicon wafer may be directly placed on a susceptor of an epitaxial growth chamber. Heating sources such as lamps or lamp banks are commonly employed to heat a silicon wafer to a predetermined temperature set point. In order to precisely control the temperature of the silicon wafer, a variety of pyrometers are employed to detect the body temperature of the silicon wafer. More particularly, a first pyrometer may be placed below the silicon wafer as well as the susceptor. The first pyrometer is used to monitor the temperature of the center of the backside of the susceptor. A second pyrometer may be placed above the top side of the silicon wafer. The second pyrometer is used to monitor the center of the top side temperature of the silicon wafer. By combining the reported temperature values from the first and the second pyrometers, an algorithm program can estimate the body temperature of the silicon wafer.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a cross sectional view of an epitaxial growth chamber and its temperature measurement apparatus in accordance with an embodiment;

FIG. 2 illustrates a perspective view of a silicon wafer placed on a susceptor in accordance with an embodiment;

FIG. 3 illustrates a flow chart of controlling a silicon wafer's temperature during an epitaxial process by adjusting each power zone's output; and

FIG. 4 illustrates a flow chart showing a feedback control system for adjusting each power zone's output so as to achieve a uniform temperature distribution on a silicon wafer.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, a wafer temperature control apparatus and method in an epitaxial growth process. The invention may also be applied, however, to a variety of semiconductor fabrication processes.

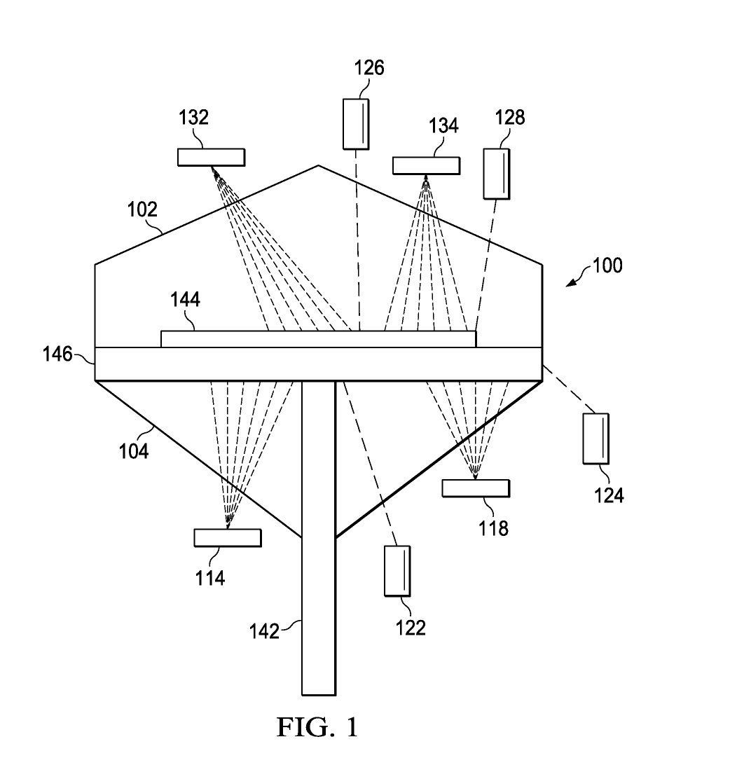

Referring initially to FIG. 1, a cross sectional view of an epitaxial growth chamber and its temperature measurement apparatus are illustrated in accordance with an embodiment. It should be noted that FIG. 1 only illustrates a simplified schematic construction of the epitaxial growth chamber 100 because the inventive aspects of the various embodiments are independent from the structure or the system configuration of the epitaxial growth chamber 100. The epitaxial growth chamber 100 illustrated herein is limited solely for the purpose of clearly illustrating the inventive aspects of the various embodiments. The present invention is not limited to any particular epitaxial growth equipment.

The epitaxial growth chamber 100 comprises an upper dome portion 102 and a lower dome portion 104. A susceptor 146 is placed within the epitaxial growth chamber 100. As shown in FIG. 1, the susceptor 146 is mounted on a rotating shaft 142. During an epitaxial growth process, a silicon wafer 144 is placed on the susceptor 146. The susceptor 146 provides mechanical support for the silicon wafer 144. Furthermore, the susceptor 146 helps to protect the backside of the silicon wafer 144 and ensure uniform heating of the silicon wafer 144. The susceptor 146 may be made of non-transparent materials such as silicon carbide, graphite with a silicon carbide coating and/or the like.

The epitaxial growth chamber 100 further comprises a variety of heating sources. The heating sources may be implemented by using resistance heaters, radio frequency inductive heaters, lamps, lamp banks and the like. In accordance with an embodiment, lamps or lamp banks are employed to heat the silicon wafer 144. Depending on the locations, the lamps or lamp banks can be further divided into the following categories. A top-inner power zone employs a lamp bank 132. Likewise, a top-outer power zone employs a lamp bank 134. Similarly, a bottom-inner power zone employs a lamp bank 114. A bottom-outer power zone employs a lamp bank 118.

In accordance with an embodiment, the lamp bank 132 may comprise 12 elongated tungsten-halogen lamps. The lamp bank 134 may comprise 20 elongated tungsten-halogen lamps. The lamp bank 114 may comprise 12 elongated tungsten-halogen lamps. The lamp bank 118 may comprise 32 elongated tungsten-halogen lamps. It should be noted while FIG. 1 shows there may be four separate lamp banks (e.g., lamp bank 132), the heating sources of the epitaxial growth chamber 100 may be implemented by using two lamp banks, namely an upper lamp bank and a lower lamp bank. Each lamp bank (e.g., upper lamp bank) may further comprise two controllable heating zones. For example, a center portion of the lamp bank can be used to heat the center portion of the silicon wafer 144. On the other hand, two side portions of the lamp bank can be used to heat the outer portion of the silicon wafer 144.

The walls of the upper dome 102 and the walls of the lower dome 104 may be made of transparent materials such as quartz. The light from the lamp banks such as top-inner lamp bank 132 may radiate through the quartz wall of the epitaxial growth chamber 100 and directly heat the silicon wafer 114 and the susceptor 146. As a result, the top side of the silicon wafer 144 is heated by the radiant thermal transfer from the lamp bank 132 and the lamp bank 134 in the top power zones. The backside of the silicon wafer 144 is heated by the conduction thermal transfer from the heated susceptor 146, which is heated by the radiant thermal transfer from the lamp banks (e.g., lamp bank 114 and lamp bank 118) in the bottom power zones.

In order to precisely control the temperature set points of the silicon wafer 144, a plurality of temperature sensors are employed to monitor the temperature values of different portions of the epitaxial growth chamber 100. In accordance with an embodiment, the temperature sensor may be a pyrometer. As shown in FIG. 1, a first pyrometer 122 is placed below the susceptor 146 and oriented such that the infra-red radiation from the heated center of the backside of the susceptor 146 is detected by the susceptor 146. A third pyrometer 126 is placed above the silicon wafer 144 as well as the upper dome 102. The third pyrometer 126 is directed at the center of the silicon wafer 144. A fourth pyrometer 128 is placed above the silicon wafer 144 and directed at the edge of the silicon wafer 144. However, the measured temperature values from the third pyrometer 126 and the fourth pyrometer 128 may be not accurate because of the emissivity effect of the silicon wafer 146. More particularly, each object may have different emitting capability. As a result, the measured temperature may not valid because the emissivity of the silicon wafer 146 may be shifted from its normal value due to other factors such as the surface evenness of the silicon wafer 146, pattern sensitive effects, the angle of observation and the like.

It should be noted while FIG. 1 shows the location of the pyrometers, the pyrometer configuration shown in FIG. 1 is merely an example. One person skilled in the art will recognize many variations, alternatives, and modifications. For example, some epitaxial growth chambers do not include a susceptor. As a result, the susceptors shown in FIG. 1 may be directed at slightly different positions. In accordance with an embodiment, the first pyrometer 122 is directed at the backside of the wafer 144 rather than the backside of the susceptor 146.

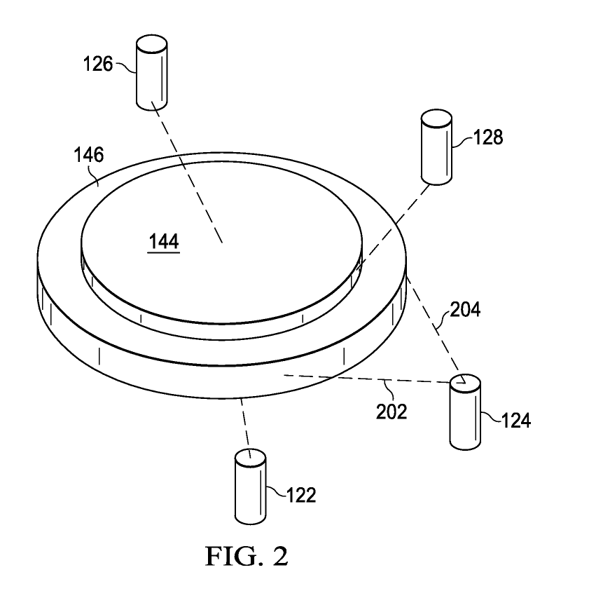

A second pyrometer 124 is employed to monitor the infra-red radiation from the edge of the susceptor 146. The second pyrometer 124 is directed at the edge of the susceptor 146. It should be noted while FIG. 1 shows the second pyrometer 124 is used to receive the infra-red radiation emitted from the right corner of the susceptor 146, the second pyrometer 124 can be directed at any point of the whole edge of the susceptor 146. The direction of the second pyrometer 124 will be better illustrated below with respect to FIG. 2. An advantageous feature of having the second pyrometer 124 monitoring the edge temperature of the susceptor 146 is that one additional temperature sampling point is employed so that a more accurate algorithm can be achieved by including the temperature value of the edge of the susceptor 146.

FIG. 2 illustrates a perspective view of a silicon wafer placed on a susceptor in accordance with an embodiment. The silicon wafer 144 (not to scale) is placed on top of the susceptor 146 (not to scale). As shown in FIG. 2, the first pyrometer 122 is directed at the center portion of the backside of the susceptor 146. Similarly, the third pyrometer 126 is directed at the center portion of the top side of the silicon wafer 144 and the fourth pyrometer 128 is directed at the edge of the wafer 144. The direction of the second pyrometer 124 is not fixed. In fact, the second pyrometer 124 can be directed at any point of the edge of the susceptor 146. For example, the second pyrometer 124 can receive the radiation energy from a point at the right side of the perspective view of the susceptor 146 (indicated by the dashed line 204). Alternatively, the second pyrometer 124 can be oriented so as to receive the radiation energy from another point in the middle portion of the perspective view of the susceptor 146 (indicated by the dashed line 202).

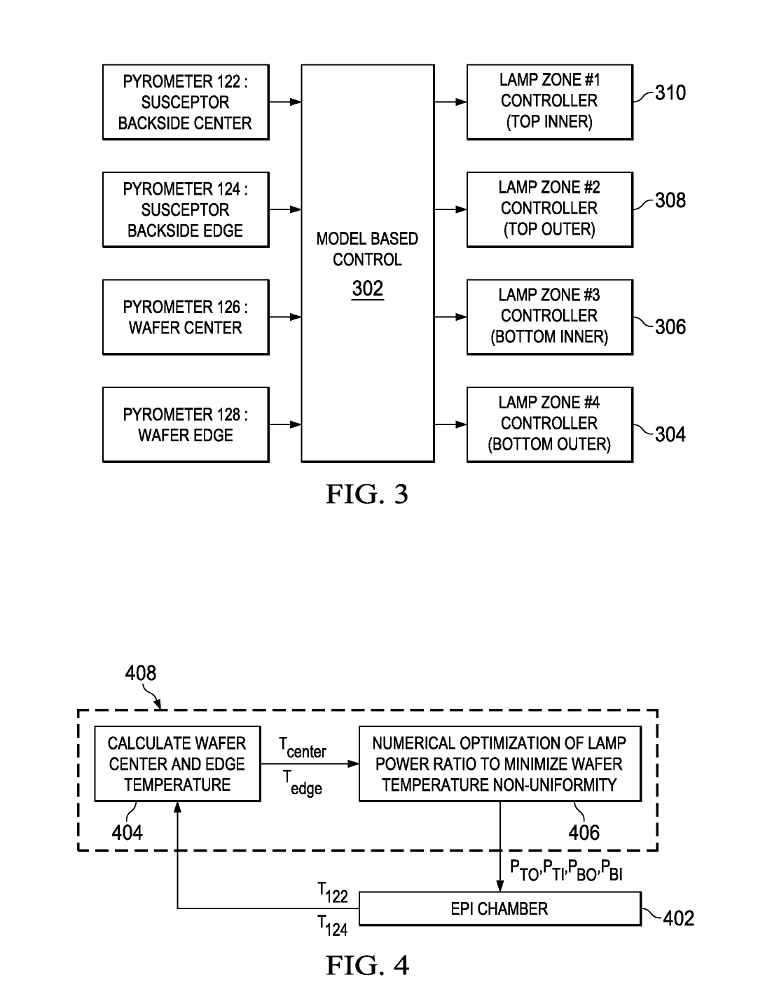

FIG. 3 illustrates a flow chart of controlling a silicon wafer's temperature during an epitaxial growth process by adjusting each power zone's output. An epitaxial growth chamber 100 (not shown) may employ three temperature sensors. In accordance with an embodiment, the temperature sensors may be implemented by using pyrometers. A first pyrometer 122 is used to monitor the temperature of the center of the backside of the susceptor 146 (not shown). A third pyrometer 126 is used to monitor the center temperature of the silicon wafer 144 (not shown). A fourth pyrometer 128 is used to monitor the edge temperature of the silicon wafer 144. A second pyrometer 124 is used to monitor the edge temperature of the susceptor 146. All detected temperature values are sent to a model based control unit 302. It should be noted that while FIG. 3 includes the third pyrometer 126 and the fourth pyrometer 128 as part of the temperature measurement system, both the third pyrometer 126 and the fourth pyrometer 128 are optional.

In accordance with an embodiment, the combination of the first pyrometer 122 and the second pyrometer 124 can provide adequate information for the model based control unit 302 to determine the temperature distribution of the silicon wafer 144. More particularly, a lookup table comprising the correlation between measured temperature values (e.g., the edge temperature from the second pyrometer 124 and the bottom center temperature from the first pyrometer 122) and the actual temperature value of each portion of the silicon wafer 144 is generated through a wafer temperature calibration process. Such a wafer temperature calibration process is known in the art, and hence is not discussed in further detail. The model based control unit 302 may use the lookup table to determine the temperature values of the upper inner, upper outer, bottom inner and bottom outer portions of the silicon wafer 144. Furthermore, the model based control unit 302 adjusts the temperature distribution of the silicon wafer 144 accordingly by changing the power output of each power zone as well as the power output ratio between different power zones. In accordance with an embodiment, the bottom edge power output is greater than other three power outputs. More particularly, the power ratio between the bottom edge power output and any one of the other three power outputs is in a range from about 2:1 to about 3:1.

The model based control unit 302 may generate four output control signals, which are sent to four power zone controllers. The first power zone controller 310 is used to adjust the temperature of the top-inner zone of the silicon wafer 144 (not shown). The second power zone controller 308 is used to adjust the temperature of the top-outer zone of the silicon wafer 144. Likewise, the third power zone controller 306 is used to adjust the temperature of the bottom-inner zone of the susceptor 146 (not shown) as well as the temperature of the bottom-inner zone of the silicon wafer 144 through conduction heat transfer. The forth power zone controller 304 is used to adjust the temperature of the bottom-outer zone of the susceptor 146.

The power zone controllers such as controller 310 may employ a feedback network upon which a corresponding lamp bank such as lamp bank 132 (not shown but illustrated in FIG. 1) may provide more power as well as radiation energy when the detected temperature value shows the top-inner zone's temperature is less than a predetermined set point. In contrast, when the top-inner zone's temperature is more than the predetermined set point, the lamp bank 132 may cut its power output accordingly. Using a feedback network to automatically adjust a lamp bank's power output so as to compensate the error between the actual temperature and the predetermined set point is within the ability of a person having ordinary skill in the art, and hence is not discussed in further detail.

FIG. 4 illustrates a flow chart showing a feedback control system for adjusting each power zone's output so as to achieve a uniform temperature distribution on a silicon wafer. An epitaxial growth chamber 402 comprises a first pyrometer 122 (not shown) and a second pyrometer 124 (not shown). The first pyrometer 122 generates a temperature signal T122, which is a value proportional to the infra-red radiation level of the bottom-inner region of the susceptor 146 (not shown). The second pyrometer 124 generates a temperature signal T124, which is a value proportional to the infra-red radiation level of the edge of the susceptor 146. Both T122 and T124 are sent to a controller 408. The controller 408 comprises two function units. The first function unit 404 receives T122 and T124 and determines a wafer center temperature and a wafer edge temperature based upon the values of T122 and T124.

Furthermore, the wafer center temperature and the wafer edge temperature are sent from the first function unit 404 to the second function unit 406. The second function unit 406 employs a feedback control algorithm to adjust each lamp bank's power output based upon the temperature difference between a predetermined wafer temperature set point and the temperature value from the first function unit 404. Four control signals PTO, PTI, PBO and PBI are generated to control each lamp bank of the epitaxial growth chamber 402. In accordance with an embodiment, PTO, PTI, PBO and PBI are used to control top-outer lamp bank 134, top-inner lamp bank 132, bottom-outer lamp bank 116 and bottom-inner lamp bank 114 respectively.

The second function unit 406 also considers the uniformity of the temperature distribution on the silicon wafer 144. For example, when the temperature of the edge portion of the silicon wafer is less than that of the center portion of the silicon wafer 144, the second function unit 406 sends a power increase signal (e.g., PTO and PBO) to both the top edge and bottom edge lamp banks. In sum, by employing an additional pyrometer monitoring the edge temperature of the susceptor 146, the epitaxial growth chamber 402 can precisely estimate the inner and outer potions' temperature and then adjust each lamp bank's power output accordingly so as to achieve a uniform temperature distribution on the silicon wafer 144.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus comprising:
a heated structure in an epitaxial growth chamber;
a first temperature sensor configured to receive a first temperature signal from a center portion of a backside of the heated structure;
a second temperature sensor configured to receive a second temperature signal from an edge portion of the heated structure; and
a plurality of heating sources adjacent to the heated structure.

2. The apparatus of claim 1, wherein the heated structure is a wafer.

3. The apparatus of claim 2, further comprising:
a third temperature sensor configured to receive a third temperature signal from a center portion of the wafer; and
a fourth temperature sensor configured to receive a fourth temperature signal from an edge portion of the wafer.

4. The apparatus of claim 1, wherein the heated structure is a susceptor.

5. The apparatus of claim 4, further comprising:
a third temperature sensor configured to receive a third temperature signal from a center portion of the susceptor; and
a fourth temperature sensor configured to receive a fourth temperature signal from an edge portion of the susceptor.

6. The apparatus of claim 1, wherein the heated structure comprises a wafer on a susceptor.

7. The apparatus of claim 6, further comprising:
a third temperature sensor configured to receive a third temperature signal from a center portion of the wafer; and
a fourth temperature sensor configured to receive a fourth temperature signal from an edge portion of the wafer.

8. The apparatus of claim 1, wherein
the first temperature sensor is a first pyrometer; and
the second temperature sensor is a second pyrometer.

9. A system comprising:
a chamber comprising:
an upper dome;
a lower dome; and
a heated structure between the upper dome and the lower dome;
a plurality of heating sources adjacent to the heated structure;
a first temperature sensor configured to receive a first temperature signal from a center portion of a backside of the heated structure;
a second temperature sensor configured to receive a second temperature signal from an edge portion of the heated structure; and
a controller configured to adjust at least one heating source's output based upon at least one of the first temperature signal and the second temperature signal.

10. The system of claim 9, further comprising
at least two heating sources placed below the lower dome; and
at least two heating sources placed above the upper dome.

11. The system of claim 9, further comprising:
a third temperature sensor configured to receive a third temperature signal from a center portion of the heated structure; and
a fourth temperature sensor configured to receive a fourth temperature signal from an edge portion of the heated structure.

12. The system of claim 11, wherein
the first temperature sensor is a first pyrometer;
the second temperature sensor is a second pyrometer;
the third temperature sensor is a third pyrometer; and
the fourth temperature sensor is a fourth pyrometer.

13. The system of claim 9, wherein the controller generates four heating source control signals for adjusting respectively:
a first output of a top inner heating source;
a second output of a top outer heating source;
a third output of a bottom inner heating source; and
a fourth output of a bottom outer heating source.

14. The system of claim 9, wherein at least one of the plurality of heating sources comprises a plurality of lamp banks.

15. A method comprising:
placing a wafer on a susceptor;
heating a wafer using a plurality of heating sources;
sensing a first temperature of a center portion of a backside of the susceptor using a first temperature sensor;
sensing a second temperature of an edge portion of the susceptor using a second temperature sensor; and
adjusting each heating source's output based upon the first temperature and the second temperature.

16. The method of claim 15, further comprising:
sensing a third temperature of a center portion of the wafer using a third temperature sensor; and
sensing a forth temperature of an edge portion of the wafer using a fourth temperature sensor.

17. The method of claim 16, further comprising:
adjusting each heating source's output based upon the first temperature, the second temperature, the third temperature and the fourth temperature.

18. The method of claim 15, further comprising:
determining a top inner region temperature and a top outer region temperature based upon at least one of the first temperature and the second temperature; and
determining a bottom inner region temperature and a bottom outer region temperature based upon at least one of the first temperature and the second temperature.

19. The method of claim 15, further comprising:
monitoring the center portion of the backside of the susceptor using a first pyrometer; and
monitoring the edge portion of the susceptor using a second pyrometer.

20. The method of claim 15, further comprising:
heating the wafer using a plurality of lamps.
